(19) United States
(12) Patent Application Publication
(10) Pub. No.: US 2023/0090302 A1
(43) Pub. Date: Mar. 23, 2023

(54) REMOTE OPERATING DEVICE, REMOTE OPERATING SYSTEM, STEERING INFORMATION DISPLAY METHOD, AND NON-TRANSITORY STORAGE MEDIUM

(71) Applicant: TOYOTA JIDOSHA KABUSHIKI KAISHA, Toyota-shi (JP)

(72) Inventor: Shuichi TAMAGAWA, Kitanagoya-shi (JP)

(73) Assignee: TOYOTA JIDOSHA KABUSHIKI KAISHA, Toyota-shi (JP)

(21) Appl. No.: 17/870,128

(22) Filed: Jul. 21, 2022

(30) Foreign Application Priority Data
Sep. 17, 2021 (JP) 2021-152140

(51) Int. Cl. G05D 1/00

(52) U.S. Cl. CPC G05D 1/0038; G05D 1/0022

(57) ABSTRACT

A remote operating device includes a steering unit configured to steer a mobile body, a display unit configured to display steering information for steering the steering unit, and a control unit. The control unit includes a memory and a processor coupled to the memory. The processor is configured to acquire a steering amount of the steering unit and an actual steering amount of the mobile body when the steering unit has been steered, measure a communication lag amount from the steering amount of the steering unit and the actual steering amount of the mobile body, compute the steering information based on the communication lag amount, and cause the steering information to be displayed on the display unit.

### CROSS-REFERENCE TO RELATED APPLICATION

This application is based on and claims priority under 35 USC 119 from Japanese Patent Application No. 2021-152140 filed on Sep. 17, 2021, the disclosure of which is incorporated by reference herein.

### BACKGROUND

### Technical Field

The present disclosure relates to a remote operating device, a remote operating system, a steering information display method, and a non-transitory storage medium.

### Related Art

Remote piloting systems such as that disclosed in Japanese Patent Application Laid-Open (JP-A) No. 2017-107374 are known. Such remote piloting systems include a mobile body, and a remote piloting device enabling the mobile body to be piloted from externally to the mobile body.

However, in a remote operating system in which a mobile body is remotely operated from a pilot seat provided externally to the mobile body, due to a communication lag between the pilot seat and the mobile body, there is a lapse between a steering timing by an operator in the pilot seat and a steering timing in the mobile body that is actually traveling.

It is therefore hard for the operator to ascertain the relationship between their steering in the pilot seat and movement of the actual mobile body. The operator might make unnecessary steering adjustments with respect to the mobile body as a result, such that the behavior of the mobile body becomes unstable.

### SUMMARY

The present disclosure obtains a remote operating device, a remote operating system, a steering information display method, and a non-transitory storage medium in which an operator remotely operating a mobile body is able to easily and accurately ascertain movement of the actual mobile body during steering.

A remote operating device according to a first aspect includes a steering unit configured to steer a mobile body, a display unit configured to display steering information for steering the steering unit, and a control unit. The control unit includes an acquisition section configured to acquire a steering amount of the steering unit and an actual steering amount of the mobile body when the steering unit has been steered, a measurement section configured to measure a communication lag amount from the steering amount of the steering unit and the actual steering amount of the mobile body, a computation section configured to compute the steering information based on the communication lag amount, and a display instruction section configured to cause the steering information to be displayed on the display unit.

In the first aspect, the steering information for steering the steering unit is displayed on the display unit based on the communication lag amount acquired by the acquisition section. Thus, even when there is a lapse between a steering timing by an operator in a pilot seat and a steering timing in the mobile body that is actually traveling due to a communication lag between the pilot seat and the mobile body, the operator remotely operating the mobile body can readily accurately ascertain the movement of the actual mobile body during steering by viewing the steering information displayed on the display unit.

A remote operating device according to a second aspect is the remote operating device according to the first aspect, wherein the steering information is a trajectory line of the mobile body.

In the second aspect, the steering information for steering the steering unit is a trajectory line. Thus, the operator remotely operating the mobile body is able to readily intuitively and accurately ascertain the movement of the actual mobile body during steering, compared to cases in which the steering information is not in the form of a line.

A remote operating system according to a third aspect includes the remote operating device according to the first aspect or the second aspect, and a mobile body configured to be remotely operated by the remote operating device.

In the third aspect, the remote operating device that remotely operates the mobile body includes the display unit that displays the steering information for steering the steering unit based on the communication lag amount acquired by the acquisition section. Thus, even when there is a lapse between the steering timing by the operator in the pilot seat and the steering timing in the mobile body that is actually traveling due to a communication lag between the pilot seat and the mobile body, the operator remotely operating the mobile body can readily accurately ascertain the movement of the actual mobile body during steering by viewing the steering information displayed on the display unit.

As described above, in the present disclosure, the operator remotely operating the mobile body is able to easily and accurately ascertain movement of the actual mobile body during steering.

### BRIEF DESCRIPTION OF THE DRAWINGS

Exemplary embodiments of the present invention will be described in detail based on the following figures, wherein:

FIG. 1 is a block diagram illustrating a schematic configuration of a remote operating system according to an exemplary embodiment;

FIG. 2 is an explanatory diagram illustrating a trajectory line displayed on a display unit of a remote operating system according to an exemplary embodiment;

FIG. 3 is a flowchart illustrating processing processes in a remote cockpit of a remote operating system according to an exemplary embodiment;

FIG. 4A is a graph illustrating lapses between a steering timing in a remote cockpit of a remote operating system according to an exemplary embodiment, a steering timing in a vehicle, and pictorial feedback being displayed on a display unit, caused by communication lag;

FIG. 4B is a graph illustrating lapses between a steering timing in a remote cockpit of a remote operating system according to an exemplary embodiment, a steering timing in a vehicle, and pictorial feedback being displayed on a display unit, caused by communication lag;

FIG. 5 is a block diagram illustrating a hardware configuration of a control unit of a vehicle according to an exemplary embodiment;

FIG. 6 is a block diagram illustrating a hardware configuration of a control unit of a remote cockpit according to an exemplary embodiment; and

FIG. 7 is a block diagram illustrating a functional configuration of a control unit of a remote cockpit according to an exemplary embodiment.

### DETAILED DESCRIPTION

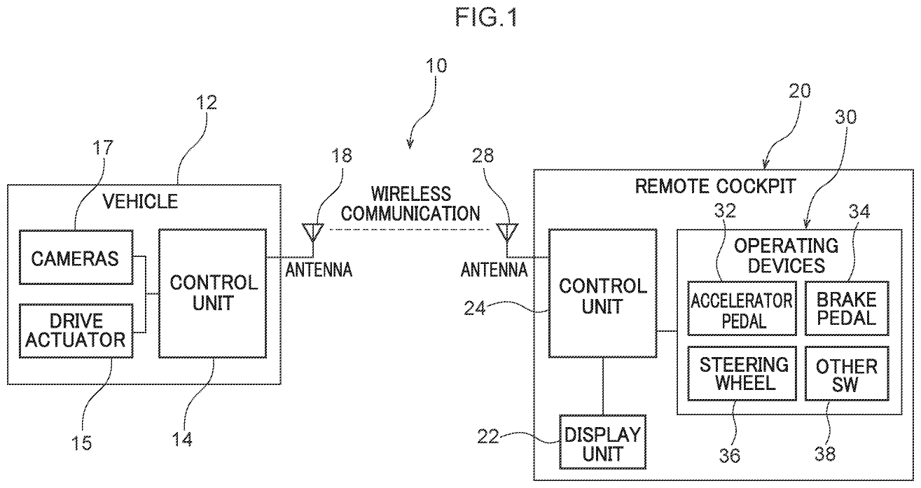

Detailed explanation follows regarding an exemplary embodiment according to the present disclosure, with reference to the drawings. As illustrated in FIG. 1, a remote operating system 10 according to the present exemplary embodiment includes a vehicle 12 serving as an example of a mobile body, and a remote cockpit 20 serving as a remote operating device including a pilot seat in which a driver (operator) sits in order to drive the vehicle 12 by remote operation externally to the vehicle 12.

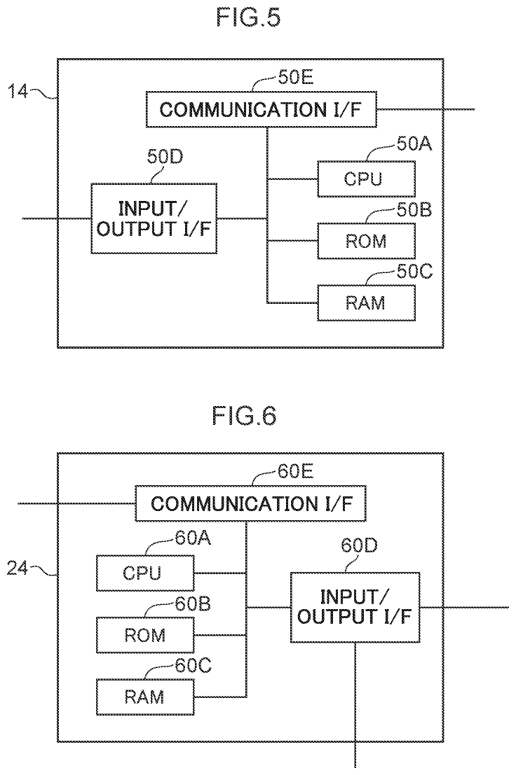

The vehicle 12 includes a control unit 14 that is electrically connected to a drive actuator 15. FIG. 5 is a block diagram illustrating a hardware configuration of the control unit 14. As illustrated in FIG. 5, the control unit 14 is configured as a microcomputer including a central processing unit (CPU) 50A serving as a processor, read only memory (ROM) 50B and random access memory (RAM) 50C serving as a memory, an input/output I/F 50D, a communication I/F 50E, and so on. The CPU 50A reads a program from the ROM 50B and executes the program with the RAM 50C serving as a workspace. By doing so, the control unit 14 receives operating instructions (control data) transmitted from the remote cockpit 20, and drives the drive actuator 15, operates an accelerator pedal (travels), operates a steering wheel (steers), operates a brake pedal (stops), and so on based on these operating instructions, so as to control actual driving.

The control unit 14 included in the vehicle 12 also includes the communication I/F 50E, this being an interface that receives the operating instructions (control data) from the remote cockpit 20 through an antenna 18 and transmits steering information required for remote driving to the remote cockpit 20.

The vehicle 12 also includes cameras 17 that capture pictures of the surroundings of the vehicle 12. The cameras 17 are provided at plural suitable positions on the vehicle 12. Note that the steering information required for remote driving that is transmitted by the communication I/F 50E includes pictures (image data) captured by the cameras 17. The cameras 17 are also electrically connected to the control unit 14.

The remote cockpit 20 includes a control unit 24. The control unit 24 includes a communication I/F 60E, this being an interface that receives the steering information required for remote driving from the communication I/F 50E through an antenna 28 and transmits the operating instructions (control data) from the remote cockpit 20 to the communication I/F 50E.

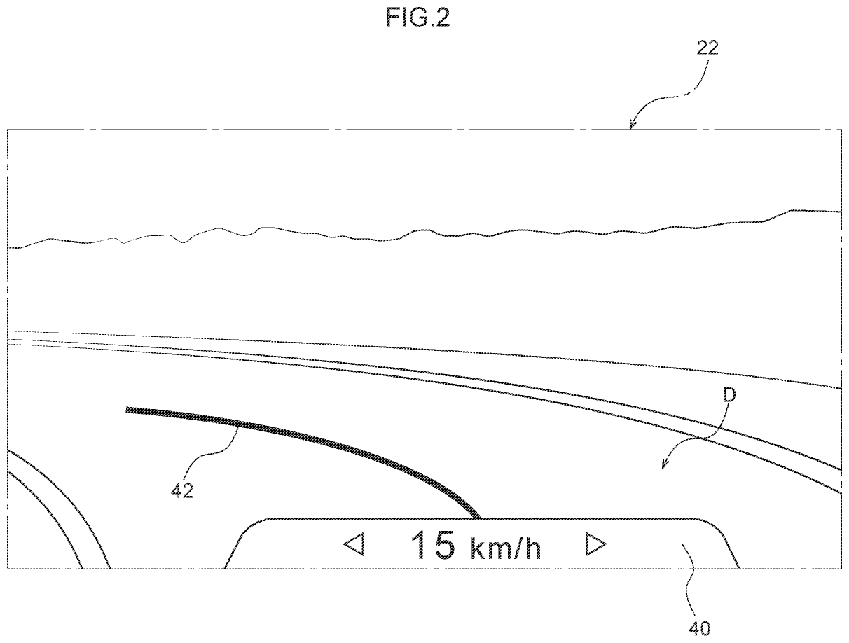

The remote cockpit 20 also includes a display unit 22 that displays actual steering information received by the communication I/F 60E, such as pictures captured by the plural cameras 17 provided to the vehicle 12. The display unit 22 is configured of plural displays, an LED device, and so on, and also displays various meters indicating states of the vehicle 12, such as a speedometer 40 (see FIG. 2) indicating the speed of the vehicle 12.

Namely, as well as displaying various meters such as the speedometer 40, the display unit 22 is capable of displaying a state of the vehicle 12, such as traveling or stationary, and is capable of visually notifying the driver of the state of the vehicle 12 when actually traveling along a road. Steering information for steering a steering wheel 36, described later, is also displayed on the display unit 22.

The remote cockpit 20 includes the control unit 24 that is electrically connected to the display unit 22. FIG. 6 is a block diagram illustrating a hardware configuration of the control unit 24. As illustrated in FIG. 6, the control unit 24 is configured as a microcomputer including a central processing unit (CPU) 60A serving as a processor, read only memory (ROM) 60B and random access memory (RAM) 60C serving as a memory, an input/output I/F 60D, the communication I/F 60E, and so on. The CPU 60A reads a program from the ROM 60B and executes the program with the RAM 60C serving as a workspace. By doing so, the control unit 24 controls the remote cockpit 20 by sending operating instructions (control data) from the remote cockpit 20 to the vehicle 12, receiving steering information required for remote driving from the vehicle 12, displaying the steering information on the display unit 22, and so on.

Note that the control unit 24 is an example of an acquisition section that acquires a communication lag amount from a steering amount of the steering wheel 36 and a steering amount of the actual vehicle 12 when the steering wheel 36 has been steered. The steering information for steering the steering wheel 36 is displayed on the display unit 22 based on this communication lag amount acquired by the control unit 24.

The control unit 24 is electrically connected to operating devices 30 for driving the vehicle 12. The operating devices 30 include an accelerator pedal 32 for accelerator operation, a brake pedal 34 for brake operation, the steering wheel 36 for steering operation, and various switches (SW) 38 for other required operations by the driver.

Namely, the control unit 24 transmits various actual driving operations and so on by the driver in the remote cockpit 20 to the vehicle 12 through the communication I/F 60E. Note that the steering wheel 36 is an example of a steering unit that steers the vehicle 12. The steering wheel 36 also employs steer-by-wire technology (an electronic control steering mechanism) to obtain steering feedback (steering reaction force) for the driver.

Explanation now follows regarding the steering information displayed on the display unit 22.

As illustrated in FIG. 2, a road D along which the vehicle 12 is traveling is displayed on the display unit 22. A trajectory line 42, this being a predicted trajectory indicating a direction in which the vehicle 12 should proceed, is displayed superimposed on a road width direction central position of the road D. The trajectory line 42 is steering information for steering the steering wheel 36 based on the communication lag amount (a proposed steering amount) computed by the control unit 24.

The trajectory line 42 is a line displayed on the display unit 22 that morphs into a straight line or a curved line according to the local state of the road D, and is illustrated as a solid line with a predetermined length. Note that the trajectory line 42 is not limited to that illustrated, and the line type, line length, line width, line color, line darkness, and so on may be changed as desired. Moreover, the line type, line width, line color, and so on of the trajectory line 42 may be preset by the driver, or automatically set by the control unit 24.

The value of the steering amount when the steering wheel 36 in the remote cockpit 20 is steered and the value of the steering amount of the steering wheel in the actual vehicle 12 when this is performed are monitored and compared, and the communication lag amount is computed by the control unit 24 from at least one of a change trend (rate of change) or average values.

Namely, in cases in which there is a communication lag between the remote cockpit 20 and the vehicle 12, there are predetermined durations lasting from the steering wheel 36 in the remote cockpit 20 being steered, to the steering wheel in the actual vehicle 12 being steered, and to this steering amount reaching the remote cockpit 20 as feedback.

Based on the communication lag amount made up of these predetermined durations, the control unit 24 estimates the steering amount of the steering wheel in the actual vehicle 12 as a result of steering the steering wheel 36 in the remote cockpit 20, computes a proposed steering amount, this being a steering amount by which the driver should steer the steering wheel 36, and displays the trajectory line 42 on the display unit 22 based on this proposed steering amount.

Namely, the trajectory line 42 is displayed on the display unit 22 in a state in which a lapse between a steering timing of the steering wheel 36 in the remote cockpit 20 and a steering timing of the steering wheel in the actual vehicle 12 has been absorbed. Thus, the driver is able to remotely operate the vehicle 12 simply by driving by trusting the trajectory line 42.

Next, explanation follows regarding operation of the remote cockpit 20 and the remote operating system 10 according to the present exemplary embodiment configured as described above.

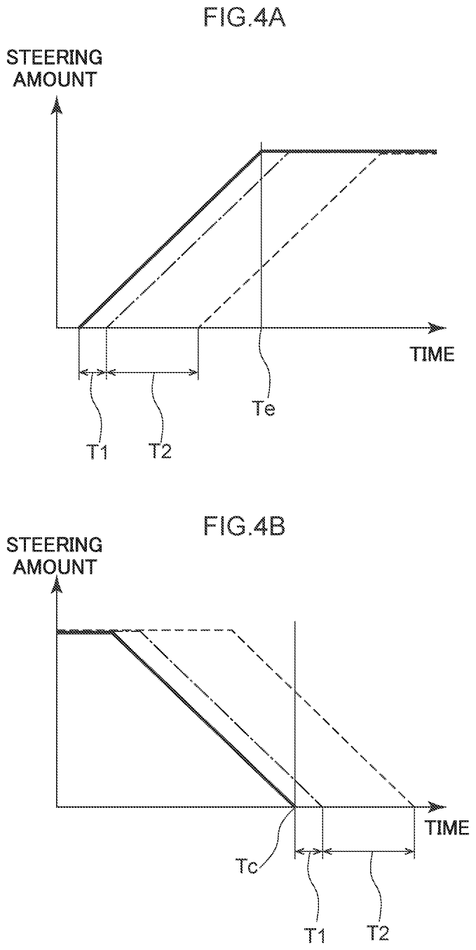

In FIG. 4A and FIG. 4B, the steering amount of the steering wheel 36 in the remote cockpit 20 plotted against time is illustrated by a solid line, whereas the steering amount of the steering wheel in the vehicle 12 plotted against time is illustrated by a single-dotted dashed line. Also in FIG. 4A and FIG. 4B, pictorial feedback of the steering wheel in the vehicle 12 is illustrated by a dashed line. Note that the pictorial feedback is displayed on the display unit 22.

As illustrated in FIG. 4A, due to the communication lag between the remote cockpit 20 and the vehicle 12, a steering timing of the steering wheel in the vehicle 12 from its neutral position is delayed by a duration T1 compared to a steering timing of the steering wheel 36 in the remote cockpit 20 from its neutral position. Namely, the duration T1 is a duration lasting until steering of the steering wheel 36 in the remote cockpit 20 is reflected as steering of the steering wheel in the vehicle 12.

Since the image data is greater in volume than the control data, due to the resulting communication lag, the pictorial feedback (indicating the steering timing from the neutral position) for the steering wheel in the vehicle 12 displayed on the display unit 22 in the remote cockpit 20 is delayed by a duration T2 compared to the steering timing of the steering wheel in the actual vehicle 12 from its neutral position. Namely, the duration T2 is a duration lasting until the steering of the steering wheel in the vehicle 12 is reflected as pictorial feedback.

Thus, even when steering of the steering wheel 36 in the remote cockpit 20 is complete (even when the steering wheel 36 in the remote cockpit 20 reaches the steering amount indicated at a timing Te), the steering of the steering wheel in the vehicle 12 depicted in the pictorial feedback displayed on the display unit 22 is still in a partial state (a steering amount of the steering wheel in the vehicle 12 depicted in the pictorial feedback at the timing Te has not yet reached the steering amount of the steering wheel 36 in the remote cockpit 20).

Namely, a duration lasting both the duration T1 and the duration T2 is required for the steering of the steering wheel 36 in the remote cockpit 20 to be reflected as pictorial feedback. Thus, if the driver in the remote cockpit 20 were to see the pictorial feedback displayed on the display unit 22, the driver might want to steer the steering wheel 36 further, such that the behavior of the actual vehicle 12 would become unstable.

Similar applies when the steering wheel 36 in the remote cockpit 20 is returned to its neutral position. Namely, as illustrated in FIG. 4B, due to the communication lag between the remote cockpit 20 and the vehicle 12, a steering timing of the steering wheel in the vehicle 12 to its neutral position is delayed by the duration T1 compared to a steering timing of the steering wheel 36 in the remote cockpit 20 to its neutral position.

Since the image data is greater in volume than the control data, due to the resulting communication lag, the pictorial feedback (indicating the steering timing to the neutral position) for the steering wheel in the vehicle 12 displayed on the display unit 22 of the remote cockpit 20 is delayed by the duration T2 compared to the steering timing of the steering wheel in the actual vehicle 12 to its neutral position.

Thus, even when the steering of the steering wheel 36 in the remote cockpit 20 is complete as far as its neutral position (even when the steering wheel 36 in the remote cockpit 20 has reached its neutral position as indicated at a timing Tc), the steering of the steering wheel in the vehicle 12 depicted in the pictorial feedback displayed on the display unit 22 is still in a partial state (a steering amount of the steering wheel in the vehicle 12 depicted in the pictorial feedback at the timing Tc has not yet reached the neutral position).

Namely, in this case also, a duration lasting both the duration T1 and the duration T2 is required for the steering of the steering wheel 36 in the remote cockpit 20 to be reflected as pictorial feedback. Thus, if the driver in the remote cockpit 20 were to see such pictorial feedback displayed on the display unit 22, the driver might want to steer the steering wheel 36 further, such that the behavior of the actual vehicle 12 would become unstable.

To address this, in the remote cockpit 20 and the remote operating system 10 according to the present exemplary embodiment, the trajectory line 42 that is steering information for steering the steering wheel 36 is displayed on the display unit 22 as described previously, such that the driver is able to easily and accurately visually ascertain the state (movement) of the actual vehicle 12.

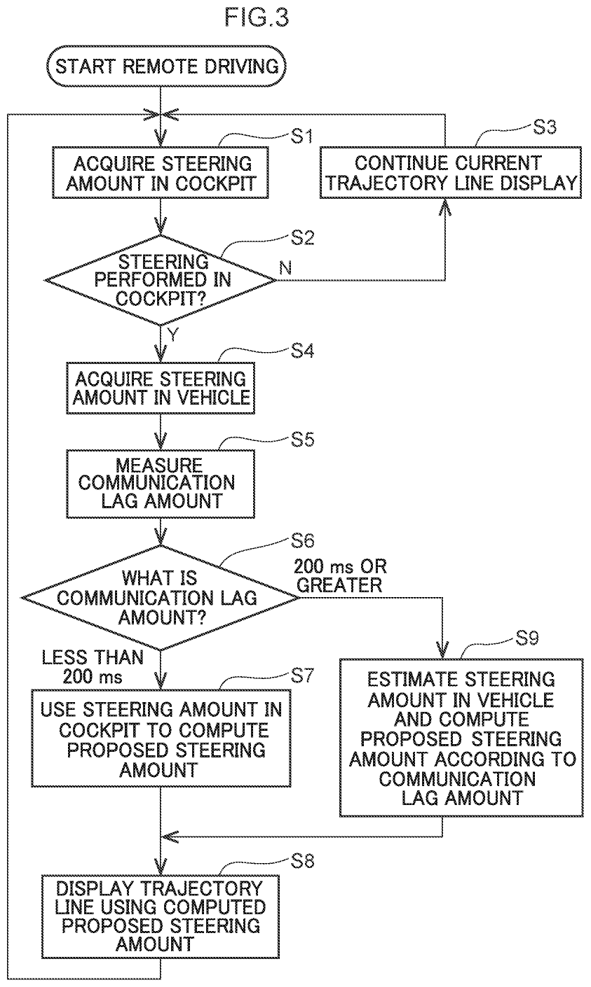

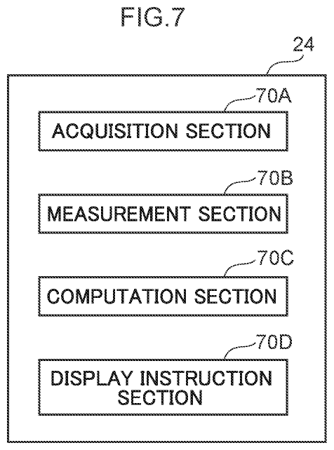

FIG. 7 is a block diagram illustrating a functional configuration of the control unit 24. The CPU 60A executes a program stored in the ROM 60B, such that the control unit 24 functions as an acquisition section 70A, a measurement section 70B, a computation section 70C, and a display instruction section 70D. As illustrated in FIG. 3, in the remote cockpit 20, first, the steering amount of the steering wheel 36 in the remote cockpit 20 is acquired by the control unit 24 serving as the acquisition section 70A (step S1). Namely, a determination is made as to whether or not the steering wheel 36 in the remote cockpit 20 has been steered from its neutral position (step S2).

In cases in which a determination is made that the steering wheel 36 in the remote cockpit 20 has not been steered from its neutral position (no steering performed), the current display of the trajectory line 42 on the display unit 22 is continued (step S3), and processing returns to step Si.

In cases in which a determination is made that the steering wheel 36 in the remote cockpit 20 has been steered from its neutral position (steering performed), the control unit 24 serves as the acquisition section 70A to acquire the steering amount of the steering wheel in the vehicle 12 from its neutral position (step S4). The control unit 24 then serves as the measurement section 70B to measure a communication lag amount from the steering wheel 36 in the remote cockpit 20 being steered to the steering wheel in the vehicle 12 being steered, and to this steering amount being fed back to the remote cockpit 20 (step S5).

Note that the value of the steering amount when the steering wheel 36 in the remote cockpit 20 is steered and the value of the steering amount of the steering wheel in the actual vehicle 12 when this is performed may be monitored and compared, and the communication lag amount may be computed in advance by the control unit 24 from at least one of a change trend (rate of change) or average values.

In cases in which the communication lag amount is for example less than 200 ms, there is no difference between the steering amount when the steering wheel 36 in the remote cockpit 20 is steered and the steering amount of the steering wheel in the vehicle 12 at this point in time. Thus, the steering amount of the steering wheel 36 in the remote cockpit 20 becomes the steering amount of the steering wheel in the vehicle 12 unaltered, and the control unit 24 serves as the computation section 70C to compute the proposed steering amount based thereon (step S7). The control unit 24 then serves as the display instruction section 70D to instruct the display unit 22 to display the trajectory line 42 according to this computed proposed steering amount (step S8).

In cases in which the communication lag amount is for example 200 ms or greater, there is a difference between the steering amount when the steering wheel 36 in the remote cockpit 20 is steered and the steering amount of the steering wheel in the vehicle 12 at this point in time. Thus, the control unit 24 serves as the computation section 70C to estimate the steering amount of the steering wheel in the vehicle 12 and compute a proposed steering amount according to the communication lag amount (step S9). The control unit 24 then serves as the display instruction section 70D to instruct the display unit 22 to display the trajectory line 42 according to this computed proposed steering amount (step S8). In the present exemplary embodiment, the above-described processes are repeatedly executed such that the trajectory line 42 is always displayed on the display unit 22.

Thus, even if there is a lapse between the steering timing (steering amount) by the driver in the remote cockpit 20 and the steering timing (steering amount) in the vehicle 12 that is actually traveling due to the communication lag between the remote cockpit 20 and the vehicle 12, the driver steers the steering wheel 36 by viewing the trajectory line 42 (by trusting the trajectory line 42) displayed on the display unit 22, thereby enabling the actual vehicle 12 to be driven in an appropriate manner.

Namely, even when a communication lag with the actual vehicle 12 has occurred, the driver driving the vehicle 12 by remote operation is able to easily and accurately ascertain the movement of the vehicle 12 using the trajectory line 42. This enables the driver to be suppressed or prevented from making unnecessary steering adjustments with respect to the vehicle 12, thereby enabling the behavior of the vehicle 12 to be suppressed or prevented from becoming unstable.

Moreover, as illustrated in FIG. 2, the steering information for steering the steering wheel 36 is the trajectory line 42, thereby enabling the driver driving the vehicle 12 by remote operation to easily and accurately intuitively ascertain the movement of the actual vehicle 12 when the steering wheel 36 has been steered, compared to cases in which the steering information is not in the form of a line.

In this manner, in the remote operating system 10 and the remote cockpit 20 according to the present exemplary embodiment, the driver in the remote cockpit 20 is able to easily and accurately, and also intuitively, ascertain the state (movement) of the vehicle 12 by viewing the display unit 22, regardless of any communication lag (such as a picture transmission lag or stoppage, or a drop in resolution or frame rate).

The remote operating system 10 and the remote cockpit 20, serving as a remote operating device, according to the present exemplary embodiment have been described above with reference to the drawings. However, the remote operating system 10 and the remote cockpit 20 according to the present exemplary embodiment are not limited to those illustrated in the drawings, and design modifications may be implemented as appropriate within a range not departing from the spirit of the present disclosure. For example, the mobile body is not limited to the vehicle 12.

Moreover, the threshold of the communication lag amount in FIG. 3 is not limited to 200 ms. Remote driving is generally no longer possible in cases in which the communication lag amount threshold is 500 ms or greater, and so the communication lag amount threshold may be any value smaller than 500 ms. Moreover, the steering information displayed on the display unit 22 is not limited to the trajectory line 42. The steering information displayed on the display unit 22 may for example take the form of a number or the like.

Namely, using 0 when the road D is a straight line (when the steering wheel 36 is at its neutral position) as a reference, a number from 1 to 5 may be displayed on the display unit 22 so as to indicate the degree at which the road D curves. In such cases, the letter R is preferably appended to the number 1 to 5 when the road D curves toward the right, and the letter L is preferably appended to the number 1 to 5 when the road D curves toward the left.

Moreover, although an example has been described in which the processing performed by the control unit 24 is software processing performed by executing a program, there is no limitation thereto. The processing may for example be processing performed by hardware. Alternatively, the processing may be performed by a combination of both hardware and software. In cases in which the processing is software processing, the program may be stored and distributed on various types of non-transitory storage media, such as a Digital Versatile Disc (DVD), and executed by a processor such as the CPU 60A.

What is claimed is:

1. A remote operating device comprising:
a steering unit configured to steer a mobile body;
a display unit configured to display steering information for steering the steering unit; and
a control unit including a memory and a processor coupled to the memory, wherein the processor is configured to:
acquire a steering amount of the steering unit and an actual steering amount of the mobile body when the steering unit has been steered,
measure a communication lag amount from the steering amount of the steering unit and the actual steering amount of the mobile body,
compute the steering information based on the communication lag amount, and
cause the steering information to be displayed on the display unit.

2. The remote operating device of claim 1, wherein the steering information is a trajectory line of the mobile body.

3. A remote operating system comprising:
the remote operating device of claim 1; and
a mobile body configured to be remotely operated by the remote operating device.

4. A steering information display method for performing remote operation, the method comprising:
by a processor:
acquiring a steering amount of a steering unit configured to steer a mobile body and an actual steering amount of the mobile body when the steering unit has been steered;
measuring a communication lag amount from the steering amount of the steering unit and the actual steering amount of the mobile body;
computing steering information based on the communication lag amount; and
causing the steering information to be displayed on a display unit.

5. A non-transitory storage medium storing a program executable by a processor to perform steering information display processing for performing remote operation, the steering information display processing comprising:
acquiring a steering amount of a steering unit configured to steer a mobile body and an actual steering amount of the mobile body when the steering unit has been steered;
measuring a communication lag amount from the steering amount of the steering unit and the actual steering amount of the mobile body;
computing steering information based on the communication lag amount; and
causing the steering information to be displayed on a display unit.
